(19) United States
(12) Patent Application Publication
(10) Pub. No.: US 2007/0137193 A1
(43) Pub. Date: Jun. 21, 2007

(54) Hydraulic lifting apparatus

(76) Inventor: Jim Seah, Platte Woods, MO (US)

Correspondence Address: POLSINELLI SHALTON FLANIGAN SUELTHAUS PC, 700 W. 47TH STREET, SUITE 1000, KANSAS CITY, MO, 64112-1802, US

(21) Appl. No.: 11/303,586

(22) Filed: Dec. 15, 2005

(51) Int. Cl. F16D 31/02

(52) U.S. Cl. 60/477

(57) ABSTRACT

The present invention relates to a hydraulic jack having two serially connected pneumatic motors for powering a hydraulically activated ram piston in a jacking cylinder. By serially connecting the pneumatic motors, there is a double pump piston stroke, over a predetermined time interval, when compared to a single pump piston stroke with a single motor hydraulic jack. This structure provides the jack with increased jacking speed, when compared to similar jacks with single pneumatic motors.

### FIELD OF THE INVENTION

The present invention relates to hydraulic lifting apparatus, commonly known as jacks or lifts. In particular, the present invention relates to hydraulic lifting apparatus, with plural pneumatic motors, that are serially coupled or connected, to provide the necessary lifting forces.

### BACKGROUND OF THE INVENTION

Conventional hydraulic jacks, that are shaped like bottles, are commonly known as bottle jacks. These bottle jacks may be designed to lift (raise) high tonnage loads, for example fifty to 100 tons. The load is anything that is raised or lifted by the jack. These high tonnage bottle jacks typically employ a single pneumatic motor for each jacking cylinder or structure, to provide the desired lifting force.

Conventional high tonnage bottle jacks have slow lifting speeds, for both no load lifting and loaded lifting. This is due to the single pneumatic motor formed of a cylinder head, a cylinder, a first piston housing, a second piston housing, a piston, a piston rod, and, a spring that surrounds the piston rod. Pressurized air, for driving the motor, is supplied through an inlet head in the cylinder, reciprocating the piston and the corresponding piston rod. The air flows into the cylinder and the air pressure forces the piston to go down. When the air is vented, the tension from the spring pushes the piston upward creating suction. The suction results in a hydraulic vacuum, where hydraulic fluid is pulled from a reservoir in a jacking cylinder, so that it can be pumped into a cavity in a ram piston (also in the jacking cylinder), for lifting a load. As a result of this structure, jack lifting speed is proportional to the frequency of the pump piston stroke and inversely proportional to the area of the ram piston of the jacking structure, resulting in the slow lifting speeds.

### SUMMARY OF THE INVENTION

The present invention improves on the contemporary art by providing two pneumatic motors that drive pump pistons. The pneumatic motors are connected or coupled serially, such that outlet, vented or exhaust air, from a first motor, is used as the inlet air for a second motor. These serially connected motors support one jacking cylinder or structure. The two motors are such that the exhaust air from the first pneumatic motor pushes the pump piston of the second pneumatic motor, when the piston of the second pneumatic motor retracts, this retraction commonly known as an upstroke. When the piston of the second motor retracts, suction is created in a hydraulic channel in jacking cylinder, where hydraulic fluid is pulled from a reservoir, so that it can be pumped (on the subsequent piston extension or down stroke) into a cavity in a ram piston (also in the jacking cylinder), for lifting a load.

As a result, the total number of piston strokes, from the pistons of the first and second motors, substantially increases for the same time period, when compared to a single pneumatic motor, driving a single jacking cylinder or structure. Accordingly, jacking speed is faster than with a single pneumatic motor on a jacking cylinder or structure, such as high tonnage jacks of the contemporary art. Moreover, since exhaust air from the first motor powers the second motor, the number of piston strokes, from the pistons of the first and second motors, is substantially increased, but the amount of energy to do so has not substantially increased.

An embodiment of the invention is directed to a jack or jack apparatus. The jack includes, a first pneumatic motor having an air inlet and an air outlet and a second pneumatic motor having an air inlet and an air outlet. There is also a jacking cylinder coupled with the pistons of the first and second pneumatic motors, and the air outlet of the first pneumatic motor is coupled with the air inlet of the second pneumatic motor.

Another embodiment of the invention is directed to a jack apparatus having at least two pneumatic motors connected serially, such that outlet air of one pneumatic motor is inlet air for the other pneumatic motor. There is also a jacking cylinder, that is coupled to the pistons for the two motors.

### BRIEF DESCRIPTION OF THE DRAWINGS

Attention is now directed to the drawing figures, where like numerals or characters indicate corresponding or like components. In the drawings:

FIG. 1 is a perspective view of a jack apparatus in accordance with an embodiment of the present invention, with the ram piston in a raised position;

FIG. 2 is an exploded view of the apparatus of FIG. 1;

FIG. 3 is a cross sectional view of the first and second motors of the apparatus in their serial connection;

FIG. 4 is a cross-sectional view of the jacking cylinder with the ram piston in a lowered position with a diagram of the hydraulic system of the apparatus of FIG. 1; and,

FIG. 5 is a detailed view of the valving of the broken line box of FIG. 4.

### DETAILED DESCRIPTION

The present invention relates to hydraulic jacks, and in particular, high tonnage bottle jacks. The apparatus of the present invention utilizes two pneumatic motors for powering a jacking cylinder. The motors are connected or coupled such that outlet air from a first motor is the inlet air for the second motor, and the pistons of the first and second motors are coupled to the jacking cylinder of the apparatus. By connecting or coupling the two motors in this manner, the number of strokes made by the pump pistons, in both the first and second motors, for lifting the ram piston of the jacking cylinder, is substantially increased over a given time interval, than would be with only a single motor in the same given time interval. As a result of this connection or coupling of the motors, two pistons provide pumping force to the jacking cylinder, resulting in increased jacking (lifting) speed, when compared to similar jacks having only a single pneumatic motor.

Throughout this document, references to directions, such as upward, downward, upper, lower, up, down, top, bottom, and the like, are made. These directional references are to typical orientations for the apparatus 20 and/or components thereof. They are exemplary only, and not limiting in any way, as they are for description and explanation purposes.

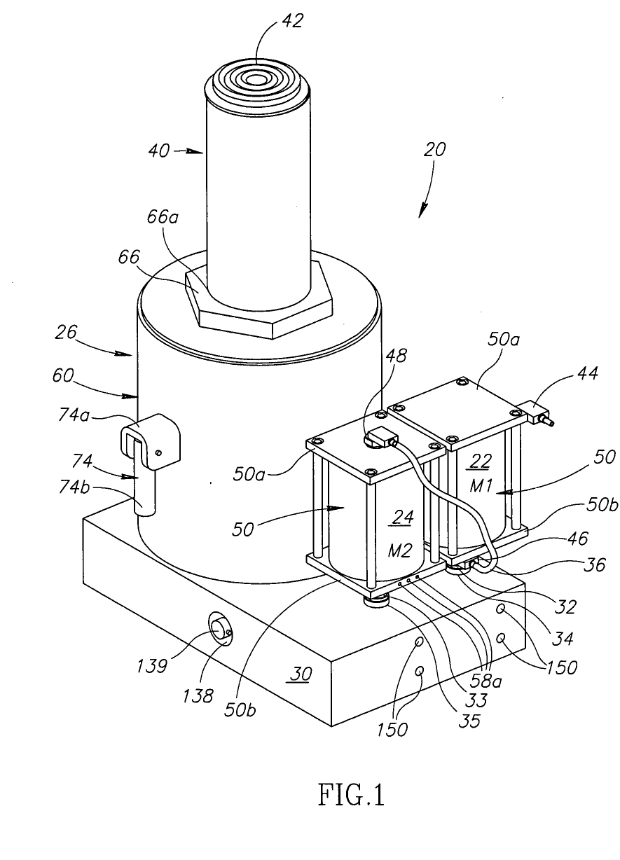

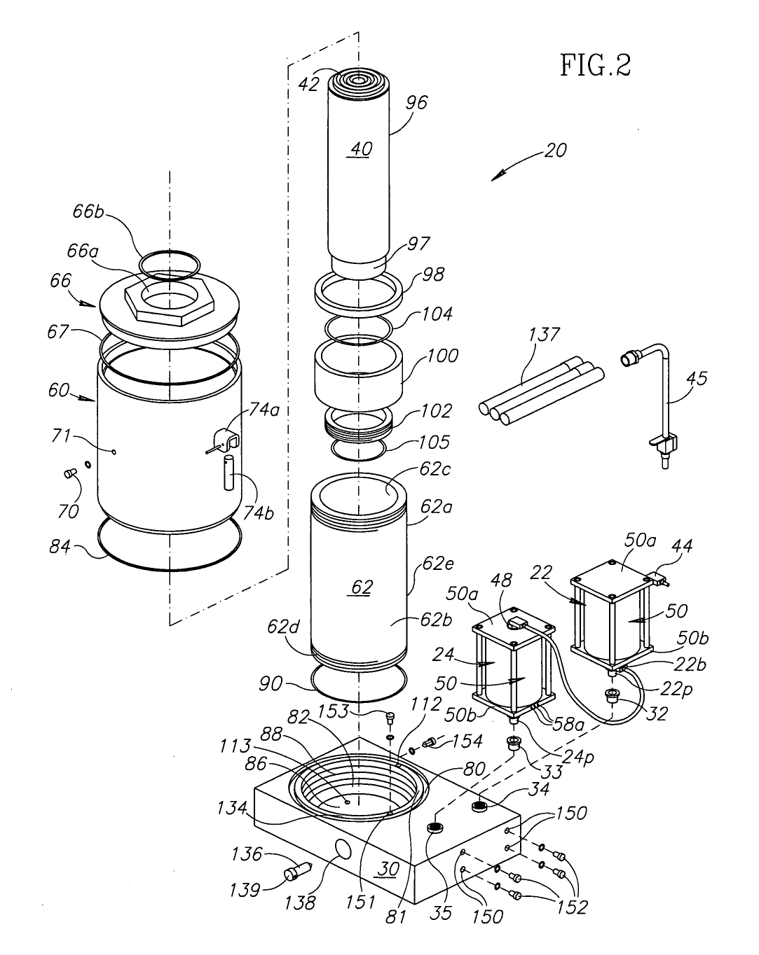

FIGS. 1 and 2 show the apparatus 20 of the present invention. The apparatus 20 includes two motors (M1) 22, (M2) 24, and a jacking cylinder 26. The motors 22, 24 and jacking cylinder 26 are supported on a base 30.

The motors 22, 24 are typically pneumatic motors. These motors, for example, provide pneumatic forces for pump pistons that can create hydraulic jacking forces of over approximately 100 tons, and typically, between approximately 50 tons to approximately 100 tons.

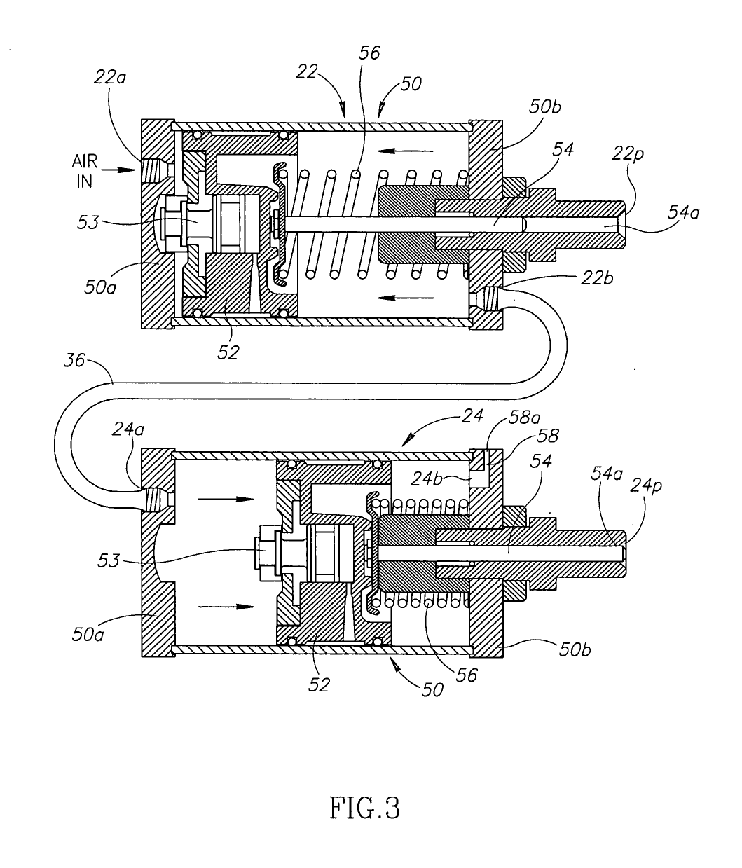

The motors 22 and 24 include inlet ports (or inlets) 22a, 24a, and outlet ports (or outlets) 22b, 24b (FIG. 3) for the ingress and egress of pressurized air. The motors 22, 24 also include piston outlet ports 22p, 24p, typically at the end of the piston rod cavities 54a of each motor 22, 24 (FIG. 3).

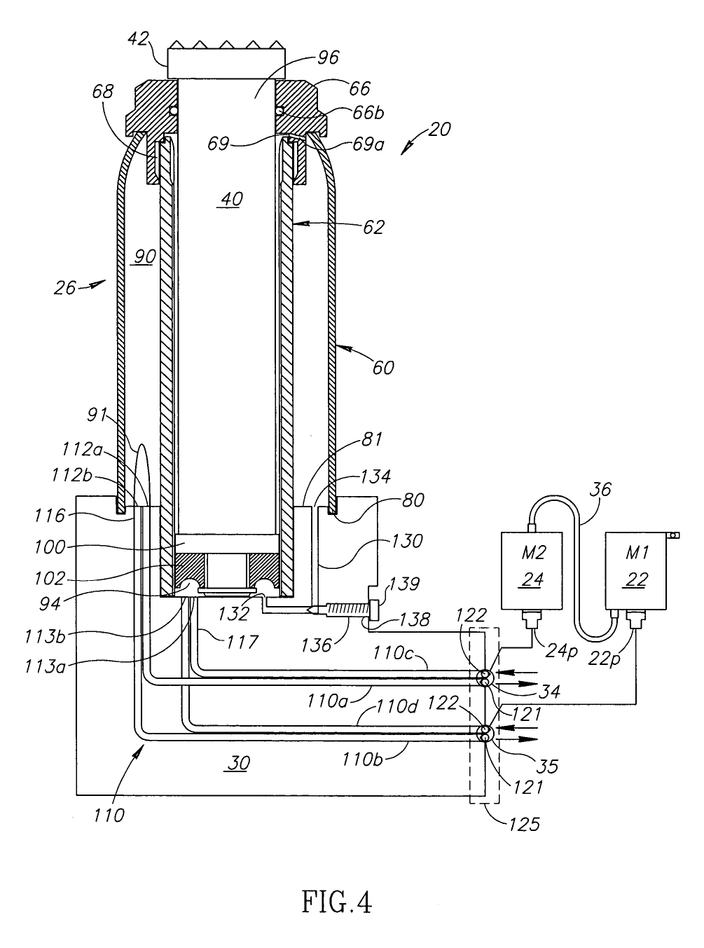

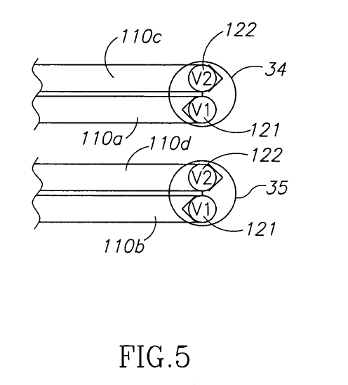

The first motor 22 attaches to the base 30, at its piston outlet port 22p. The piston outlet port 22p is received in a cartridge 32, that is received by a first opening 34 in the base 30. The second motor 24 attaches to a cartridge 33 at its piston outlet port 24p. The cartridge 33 also connects to an opening 35 in the base 30. The first opening 34 and the second opening 35 serve as the ends of the respective sub channels 110a-110d of the pumping channel 110 for hydraulic fluid, as shown in detail in FIGS. 4 and 5.

The cartridges 32, 33 typically include two independent one-way valves, oriented in opposite directions, to facilitate the motors 22, 24 pumping hydraulic fluid for lifting (the pumping process and lifting detailed below). The two one way valves may be incorporated in an apparatus, for example, the one-way valve disclosed in commonly owned U.S. Pat. No. 5,499,655 (Hung), this patent incorporated by reference in its entirety herein.

The motors 22, 24 are connected by a line 36, that connects the air outlet port 22b of the first motor 22, to the air inlet port 24a of the second motor 24 (shown in detail in FIG. 3). The line 36 is a tube, conduit or the like, for handling air at pressures of, for example, up to approximately 90 to 200 psi. The first 22 and second 24 motors, provide pressures sufficient for pumping hydraulic fluid through the pumping channel 110, that are sufficient to drive a ram piston 40 (for example, from a non-raised position, as shown in FIGS. 1 and 4, to a raised position), that in turn, lifts a saddle 42 (typically at the end of the ram piston 40). The saddle 42, as shown here, is the structure for contacting the load sought to be lifted or raised, by the jacking cylinder 26 (FIG. 4).

The motors 22, 24 each include air inlet ports 22a, 24a. The air inlet port 22a of the first motor 22 includes a connector 44, and attaches to an air inlet valve 45, that receives air, typically pressurized air, for example, at pressures of approximately 90-200 psi, from an air source (not shown). The first motor 22 terminates in the air outlet port 22b, that includes a connector 46 for receiving the line 36. The air inlet port 24a of the second motor 24 is typically positioned on top of the second motor 24, and includes a connector 48 for receiving the line 36.

FIG. 3 shows the basic design for the motors 22, 24 of the apparatus 20. These motors 22, 24 include a cylinder 50, with top 50a and bottom 50b covers, each having a pneumatic piston assembly 52, with a pneumatic piston 53 and a piston rod 54 therein. A spring 56 journals the piston rod 54 and provides a counterforce to the pneumatic piston 53. Air, under pressure, enters the cylinder 50 through the respective air inlet ports 22a, 24a (in the top covers 50a), causing the piston assembly 52, piston 53, and the piston rod 54, to reciprocate (in the direction of the oppositely disposed arrows).

In the first motor 22, the piston assembly 52 serves as a pump, to force air through the air outlet port 22b, that is off-center with respect to the piston rod 54, as the air outlet port 22b is in the bottom cover 50b of the cylinder 50. The air line 36 attaches to this air outlet port 22b, and connects at the air inlet port 24a of the second motor 24.

In both the first motor 22 and the second motor 24, the respective piston rods 54 serves as pumps, forcing fluid through the respective piston air outlet ports 22p, 24p. This reciprocation is such that on a down stroke of the piston rod 54, hydraulic fluid is forced outward from the channel 54a, at a positive pressure, causing hydraulic fluid to be pumped into the piston cavity 94, and on a piston rod 54 upstroke, fluid is moved inward, at a negative pressure, such that suction is created in the piston rod channel 54a, causing hydraulic fluid to be pulled from the reservoir 90, as also shown in FIG. 4. The piston assemblies 52 in each of the motors 22, 24 operate oppositely, such that when one piston rod 54 of one motor is on a down stroke, the other piston rod 54 in the other or opposite motor is on an upstroke, and vice versa (as indicated by the directions of the oppositely disposed arrows in the motors 22, 24 of FIG. 3).

The second motor 24, at its outlet port 24b includes a vent 58, typically in the bottom cover 50b, of the motor 24. The vent 58 includes exhaust openings 58a to the ambient environment.

The remaining components of the first 22 and second 24 motors are, for example, detailed in commonly owned U.S. Pat. Nos. 5,341,723 (Hung, et al) and 6,012,377 (Hung). Both U.S. Pat. No. 5,341,723 and U.S. Pat. No. 6,012,377 are incorporated by reference in their entirety herein.

Other suitable motors for use as either or both of the motors 22, 24, are, for example, Model Nos. A27-3-2000-104 and G24-4-2000-103, available from SFA Companies, 10939 North Pomona Avenue, Kansas City, Mo. 64153. These motors may be modified with air inlet and air outlet ports, connectors, coupling and attaching structures, and the like, so as to be connected as detailed above, in accordance with the description above.

Turning also to FIG. 4, the jacking cylinder 26 includes an outer housing cylinder 60, that surrounds a piston cylinder 62. The piston cylinder 62 serves as a guide for the ram piston 40. The ram piston 40, housing cylinder 60, and, piston cylinder 62, are typically circular in cross section and with internal bores of constant diameter. These cylinders 60, 62, are typically aligned to be coaxial. A cap 66 covers the housing cylinder 60 (with a gasket 67 therebetween). The cap 66 includes an opening 66a (with an 0-ring 66b therein that serves as a seal), through which the ram piston 40 protrudes, and moves through upon being raised and lowered. The opening 66a of the cap 66 is coaxial with the ram piston 40, housing cylinder 60, and piston cylinder 62, and is of a diameter slightly greater than the diameter of the ram piston 40, to facilitate movement of the ram piston 40, when it is being raised or lowered.

The piston cylinder 62, includes a first or upper portion 62a and a second or lower portion 62b. Along the inner wall 62c at the first or upper portion 62a, are one or more hydraulic fluid return grooves 68. The grooves 68 are coupled with a passage 69, from the inside of the piston cylinder 62 to the reservoir 90, for example, over the piston cylinder 62 and through a bore 69a in the cap 66 here, to allow for fluid bypass. This fluid bypass limits the upward travel of the ram piston 40. The position (i.e., the height) of the grooves 68 determines the height that the ram piston 40 can be raised, and accordingly, prevent against explosions of the apparatus 20. Additional details of the construction of the inner wall 62c of the piston cylinder 62 are detailed in commonly owned U.S. Pat. No. 5,946,912 (Hung), this patent incorporated by reference in its entirety herein.

The second or lower portion 62b of the piston cylinder 62 includes a threaded portion 62d, along the outer wall 62e of the piston cylinder 62. This threaded portion 62d is received in a correspondingly threaded portion in the bowl 82 of the base 30, as detailed below.

A filler plug 70 (reservoir plug or threaded filler screw), for example, a pliable rubber plug, is seated in an opening 71 in the housing cylinder 60. The filler plug 70 seals the reservoir 90 from the atmosphere (ambient environment). Handles 74 (only one shown), formed of a receiver 74a, and a hinged arm 74b, disposed on opposite sides of the housing cylinder 60, allow for the apparatus 20 to be carried.

The jacking cylinder 26 and its components are all supported by the base 30. The base 30 includes multiple channels 110, 130 for hydraulic fluid, for operation of the apparatus 20. The channels 110, 130 are formed within the base 30, and are detailed below.

The housing cylinder 60 seats in a recess 80 in the base 30, around a rim 81 that surrounds a bowl 82 in the base 30. The housing cylinder 60 typically seats on a gasket 84. The bowl 82 includes a floor 86, and threaded sidewalls 88, that are typically perpendicular to the floor 86, for receiving the piston cylinder 62 at its threaded portion 62d (the threads corresponding to the threading of the sidewalls 88) on its outer wall 62e, in a frictional engagement.

The piston cylinder 62, seats on a gasket 89 proximate to the edge of the floor 86 of the bowl 82. The piston cylinder 62 surrounds the ram piston 40. The space between the housing cylinder 60 and the piston cylinder 62, between the rim 81 and the cap 66, defines a reservoir 90 for hydraulic fluid. The hydraulic fluid may be, for example, hydraulic jack fluid or hydraulic jack oil, or the like. The reservoir 90 typically includes a filter 91 or the like, so that particulates in the hydraulic fluid are not pumped into the pumping channel 110 and the piston cavity 94.

The area beneath the ram piston 40, between the ram piston 40 and the bowl 82 of the base 30, defines a piston cavity 94. The piston cavity 94 fills with hydraulic fluid when jacking (raising of the ram piston 40) of a load is desired. When the piston cavity 94 fills, lifting (raising) of the ram piston 40 occurs.

The ram piston 40 includes a first or upper portion 96 and a second or lower portion 97. The second or lower portion 97 is of a diameter less than the diameter of the first or upper portion 96. The lower portion 97 of the ram piston 40 receives a collar 98, a ram bearing 100, and a u-cup 102, with a retainer ring 104 between the collar 98 and the ram bearing 100. Another retainer ring 105 secures the positions of the ram bearing 100 and u-cup 102 on the lower portion 97 of the ram piston 40.

The ram bearing 100 and u-cup 102, as placed onto the second or lower portion 97 of the ram piston 40, are of a diameter greater than that of the first or upper portion 96 of the ram piston 40, and of a diameter slightly less than the internal diameter of the piston cylinder 62, to allow the ram piston 40 be frictionally snug within the piston cylinder 62, while allowing for it to move up and down within the piston cylinder 62. The ram bearing 100 and u-cup 102 are also typically of a diameter slightly greater than the opening 66a of the cap 66, whereby the cap 66 may serve as an upward limit of travel for the ram piston 40.

Within the base 30, a pumping channel 110 extends from opening 112a, 112b (112 in FIG. 2) in the rim 81, corresponding to the reservoir 90, and openings 113a, 113b (113 in FIG. 2) in the floor 86, to the respective cartridges 32, 33, in the respective openings 34, 35 in the base 30. The pumping channel 110 divides into sub channels 110a-110d. These sub channels 110a-110d terminate in the cartridges 32, 33, that sit in the openings 34, 35 in the base 30. The sub channels 110a and 110b include low pressure portions 116, that extend from the opening 112 to the openings 34, 35, for the transport of hydraulic fluid from the reservoir 90 to the piston channels 54a. The sub channels 110c and 110d include a high pressure portion 117, that extends from the opening 113 in the floor 86 of the bowl 82 to the openings 34, 35, for transporting hydraulic fluid to the piston cavity 94.

The cartridges 32, 33, as discussed above, and as shown in FIG. 5, include paired one-way check valves (V1) 121, and (V2) 122, biased oppositely (in the broken line box 125). These valves (V1) 121 and (V2) 122 are controlled by pressure exerted by the pistons 53 and their corresponding piston rods 54, on the upstrokes and down strokes, that occur during operation of the apparatus 20. On the upstroke of each piston rod 54, the valve (V1) 121, biased inward (the biasing by convention, in the direction of the vertex of the <), toward the pumping channel 110, opens in response to a vacuum being created in the low pressure portion 116 of the pumping channel 110 (sub channels 110a and 110b), that pulls hydraulic fluid from the reservoir 90 (and alternately the piston cavities 54a). Oppositely, on the down strokes of the piston rods 54 in each motor 22, 24, the respective valves (V2) 122, normally biased outward (the biasing by convention, in the direction of the vertex of the >), away from the pumping channel 110, open, in response to the pressure that forces hydraulic fluid through the high pressure portion 117 of the pumping channel 110 (sub channels 110c and 110d), and into the piston cavity 94. This action of the two piston rods 54 results in hydraulic fluid being pumped into the piston cavity 94, and once the fluid enters and fills the area 94 of piston cylinder 62, the ram piston 40 lifts.

The base 30 also includes a pressure relief channel 130. The pressure relief channel 130 extends from an opening 132 in the floor 86, corresponding to the piston cavity 94, to an opening 134 in the rim 81, corresponding to the reservoir 90. A release valve 136 is threadably engaged to the base 30, and in its normal position, blocks hydraulic fluid flow through the channel 130. The release valve 136 is designed to be manually opened, by assembling a handle 137, placing the handle 137 into the opening 138 in the base 30, to contact the head 139 of the valve 136, and turning it, so that the channel 130 is opened. With the channel 130 opened, hydraulic fluid can flow from the piston cavity 94 to the reservoir 90. As hydraulic fluid leaves the piston cavity 94, and reenters the reservoir 90, the ram piston 40 (and the saddle 42) lowers.

The base includes openings 150, 151, that are filled by plugs 152, 153, 154 (the corresponding opening in the side of the base 30 is not shown). The openings are used in production of the base 30, but are not operational and are not used in the operation of the apparatus 20.

While a basic hydraulic system has been shown, this is exemplary only, as other more complicated arrangements of channels and valves in the base 30 are permissible. Moreover, under normal operating conditions, the piston rod channels 54a of the motors 22, 24, pumping channel 110, and pressure relief channel 130, and branches associated therewith, are filled with hydraulic fluid.

### EXAMPLE

A 50-ton bottle jack, constructed as detailed above, with its two motors connected serially (the “two-motor jack”), was compared against a single motor 50 ton bottle jack, Model No. 18502, from SFA Companies, Kansas City, Mo. (the “one-motor jack”). Under a no-load condition, the two-motor bottle jack constructed as detailed above, raised six inches in under 73 seconds. The SFA 50-ton one motor bottle jack raised six inches in 118 seconds. Under a 23,000 pound loaded condition, the two motor bottle jack raised six inches in 104 seconds, while the one-motor jack raised six inches in 164 seconds.

While an apparatus has been shown with two pneumatic motors connected serially, this is exemplary only, as more than two of pneumatic motors may be connected serially in accordance with the disclosure above. The serial connections between motors may be such that the air outlet port of the previous motor connects to the air inlet port of the subsequent motor by an air conduit, air line, or the like. In this manner, air from a previous motor drives the pump piston of a subsequent motor. For example, the first and subsequent motors in the series may be constructed like the first motor (M1) 22, while the last motor in the series may be constructed like the second motor (M2) 24.

While preferred embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. A jack apparatus comprising:
a first pneumatic motor including at least one piston, an air inlet, and an air outlet;
a second pneumatic motor including at least one piston, and an air inlet;
a jacking cylinder in communication with the at least one piston of the first pneumatic motor and the at least one piston of the second pneumatic motor; and,
the air outlet of the first pneumatic motor in communication with the air inlet of the second pneumatic motor.

2. The jack apparatus of claim 1, additionally comprising: a line connected to the air outlet of the first pneumatic motor and the air inlet of the second pneumatic motor.

3. The jack apparatus of claim 2, additionally comprising: a pumping channel intermediate the jacking cylinder and the first and second pneumatic motors, the pumping channel in communication with the at least one piston of the first pneumatic motor and the at least one piston of the second pneumatic motor.

4. A jack apparatus comprising:
at least two pneumatic motors connected serially, such that outlet air of one pneumatic motor is inlet air for the other pneumatic motor; and,
a jacking cylinder in communication with the at least two pneumatic motors.

5. The jack apparatus of claim 4, wherein the at least two pneumatic motors include two pneumatic motors, the two pneumatic motors defined by a first pneumatic motor including at least one piston, an air inlet, and an air outlet, and, a second pneumatic motor including at least one piston and an air inlet.

6. The jack apparatus of claim 5, additionally comprising: a line for transporting air, the line connected to the air outlet of the first pneumatic motor and the air inlet of the second pneumatic motor.

7. The jack apparatus of claim 5, additionally comprising: a pumping channel in communication with the jacking cylinder and each of the first and second pneumatic motors.

8. A method for increasing pumping capacity in a jacking cylinder, comprising:
providing a first pneumatic motor including a pump piston in hydraulic communication with a jacking cylinder, the first pneumatic motor including an air inlet and an air outlet;
providing a second pneumatic motor including a pump piston in hydraulic communication with a jacking cylinder, the second pneumatic motor including an air inlet;
placing the air outlet of the first motor into fluid communication with the air inlet of the second motor; and,
causing the pump piston in the first motor to and the pump piston in the second motor to stroke, for pumping hydraulic fluid in the jacking cylinder.

9. The method of claim 8, wherein the placing the air outlet of the first motor into fluid communication with the air inlet of the second motor includes connecting a line from the air outlet of the first motor to the air inlet of the second motor.

10. The method of claim 8, wherein causing the pump piston in the first motor to and the pump piston in the second motor to stroke includes causing the pump piston in the first motor to stroke opposite the stroke of the pump piston in the second motor.

11. A method for increasing pumping capacity in a jacking cylinder, comprising:
providing at least two pneumatic motors, each motor including a pump piston in hydraulic communication with a jacking cylinder;
connecting the at least two motors to each other serially by a mechanism including a conduit for the transport of air between the at least two motors; and,
activating each of the at least two motors such that the pump pistons in each motor stroke, and air is transferred from one motor to the other motor.

12. The method of claim 11, wherein the at least two motors include two motors, and the two motors include a first motor and a second motor.

13. The method of claim 12, wherein connecting the two motors serially to each other includes attaching a conduit for air to an air outlet port of the first motor and attaching the conduit for air to an air inlet port of the second motor.

14. The method of claim 13, wherein activating each of the at least two motors includes causing the pump piston in the first motor to stroke opposite the stroke of the pump piston of the second motor.

15. A jack apparatus comprising:
a plurality of pneumatic motors connected serially, including at least a first motor and at least one proceeding subsequent motor, such that outlet air of one pneumatic motor is inlet air for the subsequent motor; and,
a jacking cylinder in communication with the first motor and each proceeding subsequent motor.

16. The jack apparatus of claim 15, wherein the at least a first motor and at least one proceeding subsequent motor includes two pneumatic motors, the two pneumatic motors defined by a first pneumatic motor including at least one piston, an air inlet, and an air outlet, and, a second pneumatic motor including at least one piston and an air inlet.

17. The jack apparatus of claim 15, additionally comprising: a line for transporting outlet air of the one pneumatic motor such that it is inlet air for the subsequent motor.

18. The jack apparatus of claim 16, additionally comprising: a line for transporting air, the line connected to the air outlet of the first pneumatic motor and the air inlet of the second pneumatic motor.

19. The jack apparatus of claim 15, additionally comprising: a pumping channel in communication with the jacking cylinder and each of the motors.

20. The jack apparatus of claim 15, wherein each of the pneumatic motors includes a pump piston.

21. A method for increasing pumping capacity in a jacking cylinder, comprising:
providing a plurality of pneumatic motors, each motor including a pump piston in hydraulic communication with a jacking cylinder;
connecting each motor to the proceeding motor serially by a mechanism including a conduit for the transport of air between the at least two motors; and,
activating each of the at least two motors such that the pump pistons in each motor stroke, and air is transferred from one motor to the other motor.

22. The method of claim 21, wherein the at least two motors include two motors, and the two motors include a first motor and a second motor.

23. The method of claim 22, wherein connecting the motors serially includes, attaching a conduit for air to an air outlet port of one motor and to an air inlet port of the proceeding motor.

24. The method of claim 23, wherein activating each of the at least two motors includes causing the pump piston in a motor to stroke opposite the stroke of the pump piston of the proceeding motor.
